(19) United States
(12) Patent Application Publication
(10) Pub. No.: US 2014/0310047 A1
(43) Pub. Date: Oct. 16, 2014

(54) SIMPLIFYING SCHEDULING OF DEPENDENT TASKS IN A COLLABORATIVE PROJECT MANAGEMENT ENVIRONMENT

(71) Applicant: ORACLE INTERNATIONAL CORPORATION, Redwood Shores, CA (US)

(72) Inventors: Niladri Sekhar De, Hyderabad (IN); Srinivasu Dudala, Hyderabad (IN); Surya Vedula, Hyderabad (IN)

(73) Assignee: Oracle International Corporation, Redwood Shores, CA (US)

(21) Appl. No.: 13/861,421

(22) Filed: Apr. 12, 2013

(51) Int. Cl. G06Q 10/10

(52) U.S. Cl. CPC G06Q 10/103; G06Q 10/1097
USPC 705/7.21

(57) ABSTRACT

An aspect of the present invention simplifies scheduling of tasks of a project. In an embodiment, a user is provided the ability to specify a rejected list of dependencies, and such rejected dependencies are excluded when inferring dependencies between tasks of the project. The user may continue to add a set of tasks, have the dependencies (with the exclusion of rejected dependencies) inferred, reject more of the inferred dependencies, have the rejected dependencies added to the rejected list, during successive iterations. The output of such iterations may be processed further by a scheduling tool.

### BACKGROUND OF THE INVENTION

1. Technical Field

The present disclosure relates to project management systems and more specifically to simplifying scheduling of dependent tasks in a collaborative project management environment.

2. Related Art

A project is generally characterized by multiple tasks, the performance of which is expected to meet the various objectives of the project. Projects are characterized as multiple tasks, for reasons such as planning, allocation of right task types to resources/people with appropriate skills set and time availability. The tasks may be further divided as sub-tasks for similar or other reasons.

A task is said to be dependent on another task, if the start or finish (or both) of the task is deemed to have a specific temporal relation with the start or finish (or both) of the another task. For example, it may be required that a first task end before a second task can start, in which case the second task is dependent on the first task.

Project management, as used herein, refers to the use of a computer implemented planning or coordination approach. Thus, typical actions of project management entail creation of tasks or sub-tasks (hereafter collectively referred to as “tasks”) by entering the relevant details, allocation of resources for performance of each task, scheduling of the tasks (by specifying start and/or finish dates for each task) while satisfying dependencies (and any other criteria), monitoring the status of the tasks/allocations, etc., to ensure timely completion of the project.

There are often situations when project management is performed in a collaborative manner, instead of a single person having the responsibility for all the project management actions noted above. Thus, collaboration here implies that multiple people may independently perform the various project management actions noted above. For example, different people may independently be creating tasks for the same project.

Thus, additional challenges may be presented to scheduling aspect, in view of such a collaborative project management environment.

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flow chart illustrating the manner in which the scheduling of dependent tasks in a collaborative project management environment is simplified according to an aspect of the present invention.

FIGS. 3A-3E together illustrates the manner in which scheduling of dependent tasks in a collaborative project management environment is simplified in one embodiment.

FIG. 4 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention simplifies scheduling of tasks of a project. In an embodiment, a user is provided the ability to specify a rejected list of dependencies, and such rejected dependencies are excluded when inferring dependencies between tasks of the project. The user may continue to add a set of tasks, have the dependencies (with the exclusion of rejected dependencies) inferred, reject more of the inferred dependencies, have the rejected dependencies added to the rejected list, during successive iterations. The output of such iterations may be processed further by a scheduling tool.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

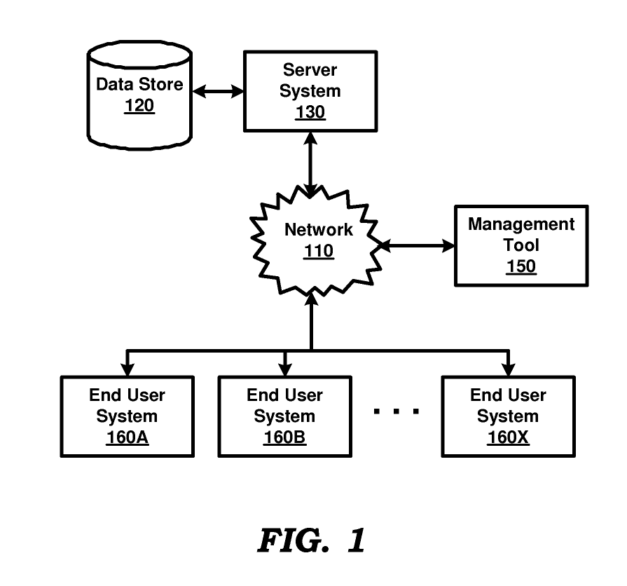

FIG. 1 is a block diagram illustrating an example environment in which several aspects of the present invention can be implemented. The block diagram is shown containing network 110, data store 120, server system 130, management tool 150 and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 130, management tool 150 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the details of the tasks, resources, and allocations of resources to the various tasks) by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Server system 130 represents a server, such as a web/application server, executing applications (such as a project management application that enables users to manage tasks, resources and the allocations between them) capable of processing (user) requests received from users using one of end user systems 160A-160X. The server system may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

Each of end user systems 160A-160X represents a system such as a personal computer, workstation, mobile station, mobile phones, computing tablets, etc., used by users to generate (user) requests directed to applications executing in server system 130. The requests may be generated using appropriate user interfaces. For example, a manager may use an end user system to send user requests for managing the various tasks, resources and the corresponding allocations between them. On the other hand, an end user (also using an end user system) may send user requests to determine the specific tasks allocated to him/her (the resource), the start and end dates of the allocated tasks, etc.

However, in a collaborative project management environment such as projects employing Agile or Scrum techniques, instead of a single person, many of the users/members working on an Agile/Scrum project are facilitated to perform several of the project management actions. Thus, a user (using one of end user systems 160A-160X) may add new tasks to a project, break down (previously assigned or new) tasks into one or more new sub-tasks, specify a start date and finish date for each of the new task/sub-task, etc. Multiple users collaboratively add desired tasks to the project as a matter of course over time, often without specifying the dependencies among the tasks.

Accordingly, a user/manager (overseeing the progress of the project and) wishing to optimize the scheduling of the tasks in the project may face several challenges. One challenge is that the user/manager may be required to manually specify the dependencies among the various tasks added by the different users. However, such manual specification of the dependencies even for a medium scale project (e.g., having 100-1000 tasks) may be laborious, time consuming and prone to errors (e.g., missing of some of the dependencies). The manual requirement is further compounded by the continuous addition of new tasks (without dependency information) to the project.

Management tool 150, provided according to several aspects of the present invention, simplifies the scheduling of dependent tasks in a collaborative project management environment, while overcoming at least some of the challenges noted above. The manner in which management tool 150 may simplify scheduling of dependent tasks is described below with examples.

### 3. Simplifying Scheduling of Dependent Tasks

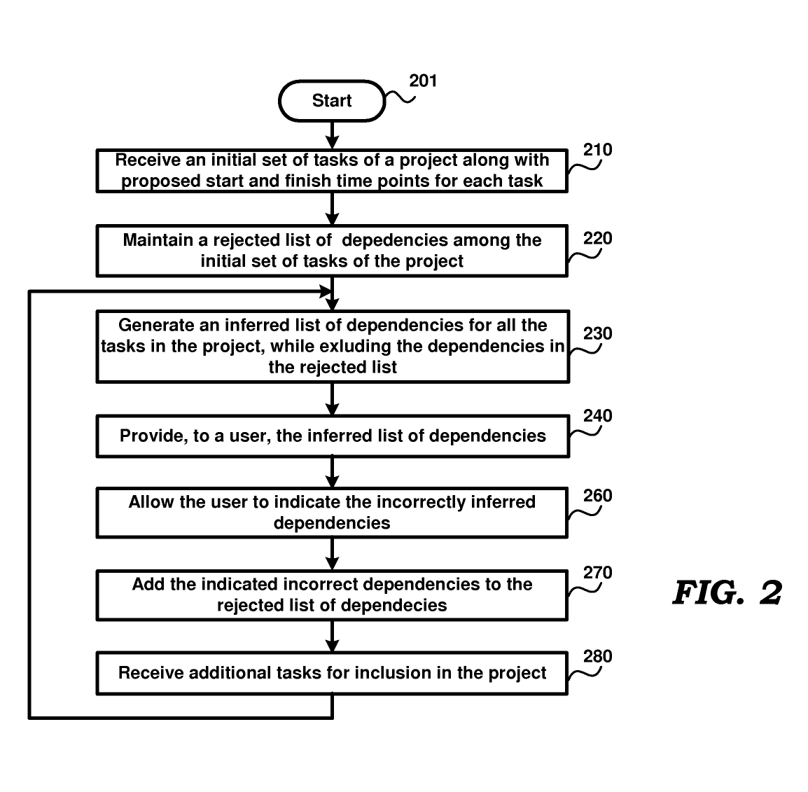

FIG. 2 is a flow chart illustrating the manner in which the scheduling of dependent tasks in a collaborative project management environment is simplified according to an aspect of the present invention. The flowchart is described with respect to the systems of FIG. 1, in particular, management tool 150, merely for illustration. However, the features can be implemented in other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, management tool 150 receives an initial set of tasks of a project, along with the proposed start and finish time points for each task. Each time point may be received in the form of an absolute or relative date/time. The tasks and dependencies may be received from a project management application executing on server system 130, from data store 120 based on prior project management actions performed by various users, or any other source.

In step 220, management tool 150 maintains a rejected list of dependencies among the initial set of tasks of the project. The rejected list is initialized to empty to start with in an embodiment, though in alternative embodiments, the rejected list may be populated based on pre-configurations as well.

In step 230, management tool 150 generates an inferred list of dependencies for all the tasks in the project, while excluding the dependencies in the rejected list. The dependencies are inferred based on the start and finish time points of each task in the project. For example, in a scenario that a second task has a start time point after the finish time point of a first task, the second task is inferred to be dependent on the first task. The corresponding dependency information is included in the generated list only if the inferred dependency is not contained in the rejected list of dependencies.

Due to such inference, the manual effort required by the user may be reduced. As described below, due to the exclusion of the rejected dependencies, the user is provided a convenient mechanism to avoid repetition of potentially erroneously inferred dependencies in the provided list, as the tasks are added in each successive iteration.

In step 240, management tool 150 provides the list of inferred dependencies to a user, for example, in the form of display on a display unit. In step 260, management tool 150 allows the user to indicate incorrectly inferred dependencies. Any convenient user interface (e.g., graphical) may be provided for the providing of step 240 and the indication of step 260.

In step 270, management tool 150 adds the indicated incorrect dependencies to the rejected list of dependencies. As may be readily appreciated, such addition ensures that the incorrect dependencies are not included in the inferred list of step 230, when generated during subsequent iterations. The overhead to the user is accordingly further reduced.

In step 280, management tool 150 receives additional tasks for inclusion in the project. As noted above, such additional tasks may be received from any of the users/members of the project using one of end user systems 160A-160X. Control then passes to step 230 for the next iteration (with the additional tasks included in the project, along with the initial set of tasks and any previously included additional tasks).

The loop of steps 230-280 may be continued for each set of additional tasks a user may wish to add. The flow chart thus enables a user to conveniently determine the set of dependencies that are to be further processed in optimizing the scheduling of various tasks. The convenience is augmented due to the use of the rejected list during such determination. The manner in which such determination may be facilitated is described below with examples.

### 4. Illustrative Examples

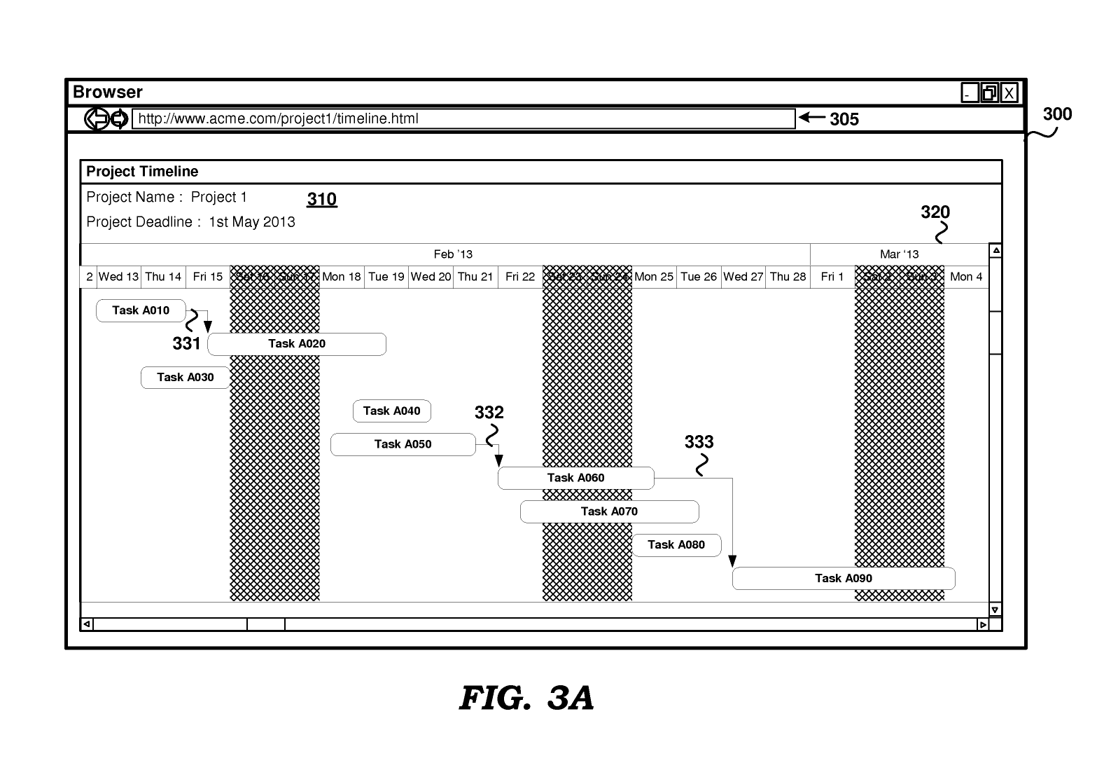

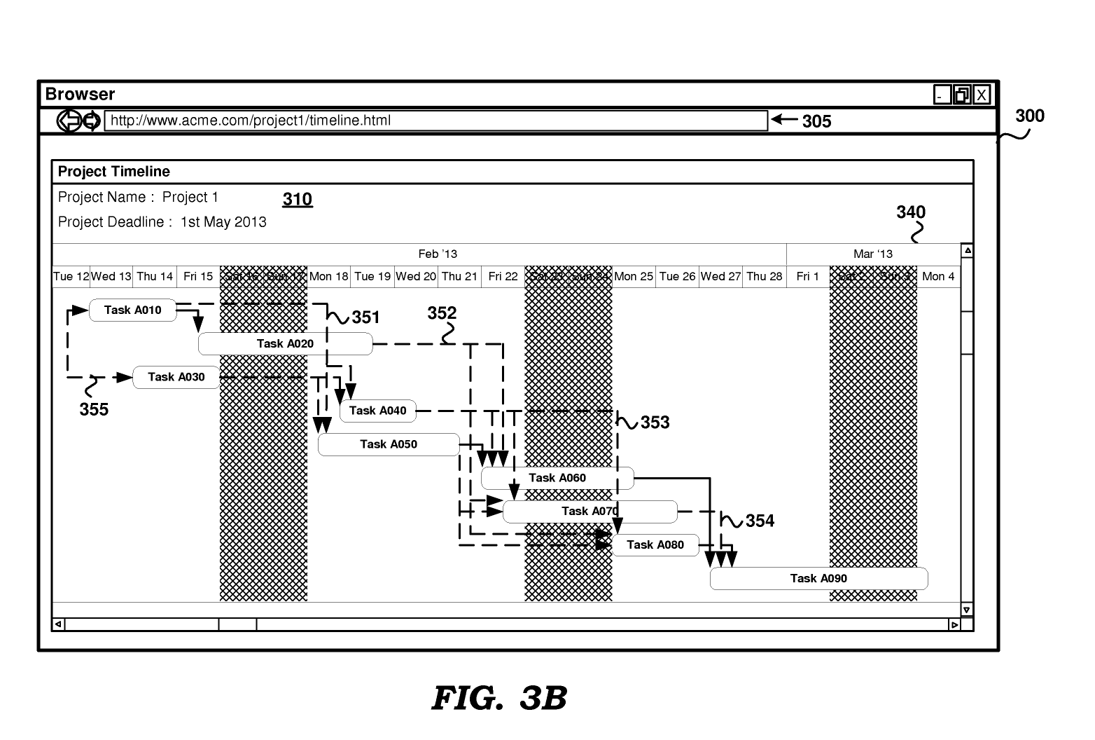

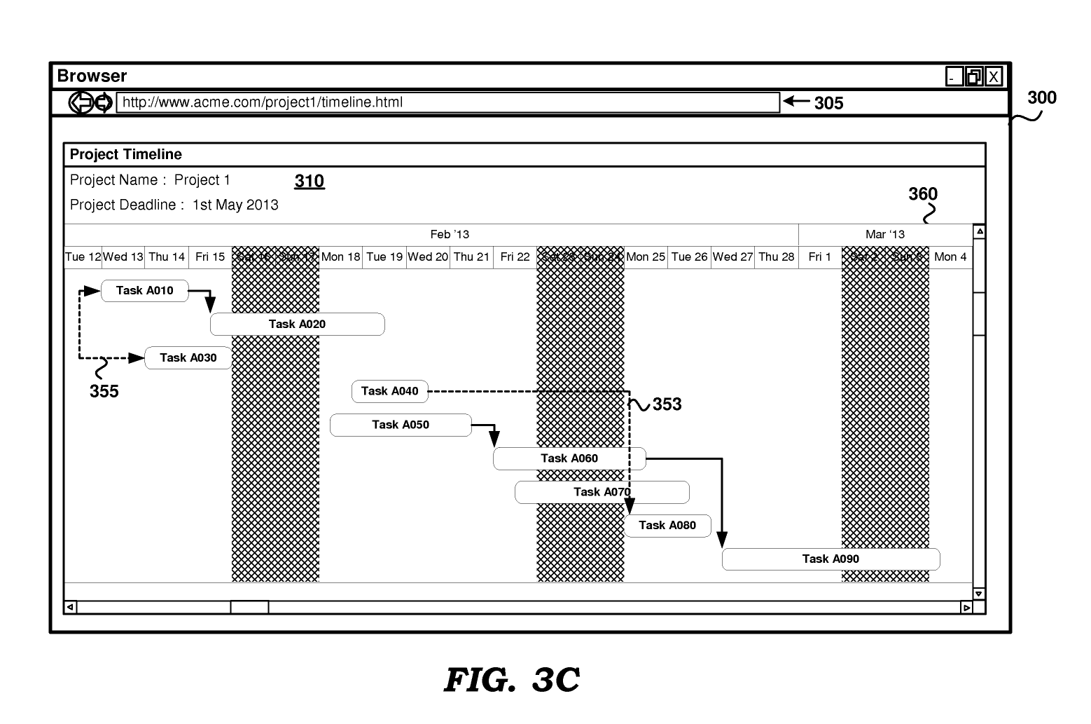

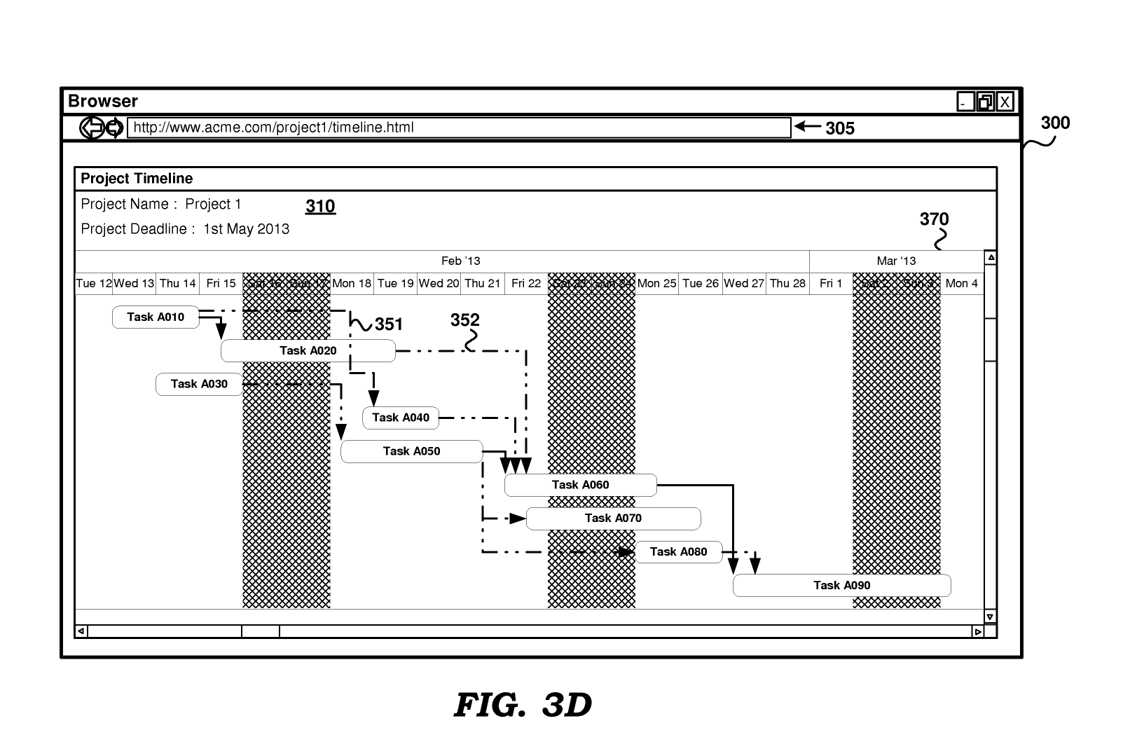

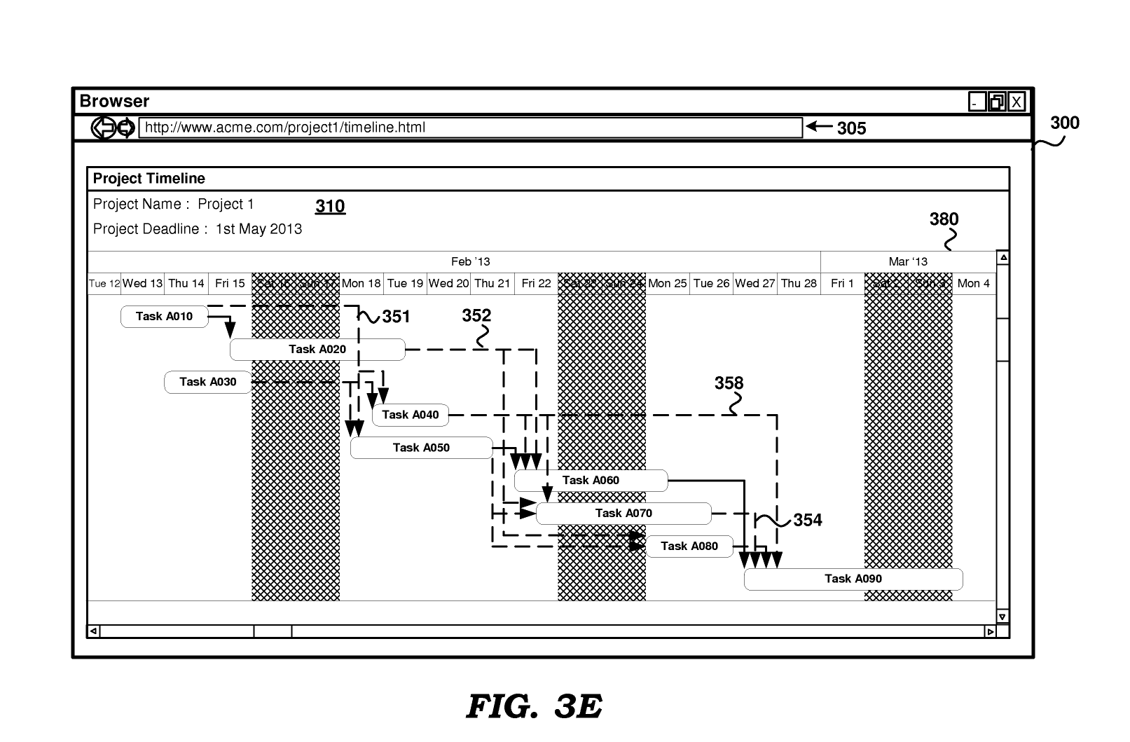

FIGS. 3A-3D together illustrates the manner in which scheduling of dependent tasks in a collaborative project management environment is simplified in one embodiment. Each of the Figures is described in detail below.

Display area 300 of FIGS. 3A-3D depicts a portion of a user interface provided on a display unit (not shown in FIG. 1) associated with one of end user systems 160A-160X (assumed to be 160A for illustration). Display area 300 corresponds to a webpage accessed by the users using a browser in response to sending a request (including an identifier of the webpage, as indicated by the text in display area 305) from end user system 160A to management tool 150. The web page is received from management tool 150 prior to being displayed (using the browser) on the display unit. Display area 310 of FIGS. 3A-3D displays the details of a project (currently displayed) such as the project name “Project 1” and the project deadline “1 May 2013”.

Referring to FIG. 3A, display area 320 provides a timeline of the various tasks in the project. In display area 320, a timeline indicating the various days of interest is shown displayed along the horizontal direction. The timeline is shown indicating the months (such as “February '13” and “March '13”) and the corresponding days (Monday, Tuesday, etc.) of interest in each of the months. Furthermore, non-working days such as Saturdays and Sundays are shown shaded as cross-hatched to indicate the non-availability (for allocation) of the resources during such days.

Display area 320 also displays the various tasks of the project below the timeline. Each tasks is shown in the form of a rounded rectangle with the name of the task (such as “Task A010”, “Task A020”, etc.) shown in the middle of the rectangle. The width (along the horizontal direction) of the rectangle indicates the duration of the corresponding task, with the rectangle shown between the proposed start and finish time points of the task. Thus, it may be appreciated that tasks A010 and A030 represent tasks that are to be performed towards the beginning of the project, and accordingly may not be dependent on any previous tasks. On the other hand, tasks A080 and A090 represent tasks that are to be performed later in the project and accordingly may be dependent on the previous tasks. Also, tasks A040 and A050 (and similarly, A060, A070 and A080) represent tasks that are to be performed simultaneously/in parallel by multiple resources.

Each of dependencies 331-333 (shown in solid lines) represents a dependency already specified/accepted by a user/manager in previous iterations. These represent the real dependencies confirmed by a user in any previous iterations, and are later used during scheduling. It may be appreciated that each of dependencies 331-333 represents a Finish-to-Start dependency, indicating that the next/dependent task (such as A020, A060 and A090) cannot be started until the previous task (such as A010, A050 and A060) has finished. It may be appreciated that the same task (such as A060) may be a dependent task having a dependency with a previous task, while also having other subsequent tasks being dependent on the same task.

It should be noted that various other types of dependencies may exist between two tasks (A and B), such as Finish-to-Finish dependency indicating that task B cannot finish before task A is finished, Start-to-Start dependency indicating that task B cannot start before task A starts, and Start-to-Finish dependency indicating that task B cannot finish before task A starts. For illustration, the same line notations (solid line, dashed line, dotted line) are used to represent the different types of dependencies. However, in alternative embodiments, convenient graphical notations (e.g., different colors or different line styles) may be chosen for specifying the various types of dependencies between the tasks.

Thus, the interface of FIG. 3A depicts various tasks of a project and the real dependencies existing among the tasks. Management tool 150 may be requested to find inferred dependencies for such a set of tasks and dependencies. Such a request may be received in response to a user selecting/clicking a button (not shown in display area 300) to indicate that the dependencies are to be inferred. Alternatively, the dependencies may be inferred in response to the user adding new tasks. The description is continued assuming that tasks A010, A020, A030, A050, A060 and A090 shown in display area 320 are received as the initial set of tasks in the project, and that management tool 150 is performing the steps of FIG. 2 in response to receiving additional tasks A040, A070 and A080.

Management tool 150 may according receive (for example, from a project management application executing on server system 130) the details of the tasks, the accepted dependencies 331-333, and any rejected dependencies for the initial set of tasks. Since the user has not previously indicated any rejected/incorrect dependencies, the rejected list of dependencies is set to empty. Management tool 150 then generates the inferred list of dependencies based on above noted initial set of tasks and rejected list as described below with examples.

### 5. Generating and Providing Inferred List of Dependencies

In one embodiment, management tool 150 infers the various dependencies among the tasks based on the start and finish time points of the tasks. In the embodiment described below, management tool 150 is enabled to infer only the Finish-to-Start and Start-to-Start type of dependencies among the tasks of the project. However in alternative embodiments, management tool 150 may be enabled to infer the other types of dependencies as well, as will be apparent to one skilled in the relevant arts by reading the disclosure herein.

Management tool 150, accordingly, first identifies for each task in the project, a corresponding list of previous tasks whose finish time points are before the start time point of the task, and then adds (to the inferred list) a Finish-to-Start dependency between the task and each previous task in the corresponding list. For example, for task A040, management tool 150 identifies the previous tasks as A010 and A030 (and not A020, since that task finishes after the start of A040), and according adds the Finish-to-Start dependencies between the tasks A010 & A040 and also between A030 & A040. Management tool 150 similarly identifies all the Finish-to-Start dependencies for the other tasks in the project.

Management tool 150 then determines the tasks for which no Finish-to-Start dependencies could be inferred (using the technique noted above). Such tasks (e.g., A010 and A030) are determined to be the first tasks that are to be performed at the beginning of the project. Management tool 150 accordingly adds (to the inferred list) Start-to-Start dependencies among all such determined tasks, with the task having the earliest time point being the predecessor of all other such tasks.

Management tool 150 then checks whether any of the newly inferred/added dependencies are contained in the rejected list, and removes any such dependencies from the inferred list. Since the rejected list is empty during this iteration, no dependencies are removed in this step during this iteration.

Management tool 150 then scans through the inferred list to search for the following redundantly inferred dependency scenarios:

a. Task A is a Finish-to-Start predecessor task of a task group B, and also of a task C;

b. Task group B contains either a single task or a sequence of Finish-to-Start dependent tasks, the dependencies being any permutation/combination of either normal/accepted Finish-to-Start dependency or inferred Finish-to-Start dependency; and

c. The last task in task group B is also a Finish-to-Start predecessor of task C.

For each set of tasks found matching the redundantly inferred dependency scenario, management tool 150, removes (from the inferred list) the Finish-to-Start dependency from task A to task C. Thus, management tool 150 ensures that the inferred list does not include any redundantly inferred dependencies, in addition to the rejected dependencies (as noted above).

Management tool 150 also computes the difference between finish and start time points of all the Finish-to-Start dependencies in the inferred list, as inferred Finish-to-Start dependency lag, for each corresponding inferred Finish-to-Start dependency. Also, management tool 150 computes the difference between the start time points in each Start-to-Start dependency in the inferred list, as Start-to-Start dependency lag.

Such dependency lag is often used in project planning/scheduling to specify the minimum offset required between the task boundaries for proper execution of the tasks. By computing and providing/displaying the dependency lags, a user/manager is facilitated to accept the desired computed lags and perform scheduling with the accepted lags. However, the user/manager may also manually specify the dependency lags among the tasks (thereby overriding the computed lags), and then perform the scheduling of the project.

After generating the inferred list of dependencies while excluding the dependencies in the rejected list, management tool 150 then provides the inferred list to a user. In one embodiment, the inferred list of dependencies is displayed to the user similar to the interface of FIG. 3A, as described in detail below.

Referring to FIG. 3B, display area 340 displays the various tasks of the project (similar to display area 320) and also the inferred list of dependencies. Each of the inferred dependencies (such as 351-355) is shown as a corresponding dashed line between the tasks (between which the dependency has been inferred). While each of dependencies 351-354 represents an inferred Finish-to-Start dependency, dependency 355 represents an inferred Start-to-Start dependency.

It may be observed that each of the tasks (such as A040 and A070) is shown having a Finish-to-Start dependency with each of the previous tasks (A010, A030 for A040 and A040, A050 for A070) respectively. However, no Finish-to-Start dependency is shown between A010 & A060, A020 & A070, and A040 & A090, since each of these dependencies match the redundantly inferred dependency scenario noted above, and is accordingly removed from the inferred list.

Thus, the inferred list of dependencies is provided to a user/manager. The user/manager may thereafter indicate the status (accepted, rejected, etc.) of the displayed inferred dependencies, as described below with examples.

### 6. Indicating Status of Dependencies

After the display of the inferred dependencies in display area 340, a user/manager may indicate which of the inferred dependencies are correct/accepted (thereby converting the inferred dependencies to a real dependencies, noted above) or incorrect/rejected (thereby causing such dependencies to be added to the rejected list). The user/manager may indicate the correct and incorrect dependencies in any convenient manner. For example, when a user selects a dependency shown in display area 340, management tool 150 displays options to either accept or reject the dependency. The user may accordingly choose the desired option to indicate whether the selected dependency is accepted/correct or rejected/incorrect.

It should be appreciated that the accepted dependencies (similar to dependencies 331-333) are later forwarded and used by a scheduling tool (not shown) when scheduling the tasks of the project. On the other hand, the incorrect dependencies added to the rejected list are not included in the inferred list during subsequent iterations of the steps of FIG. 2. The manner in which a user/manager may specify incorrect/rejected dependencies is described in detail below.

Referring to FIG. 3C, display area 360 displays the various tasks of the project (similar to display area 320) and also the various dependencies indicated to be incorrect by the user/manager. Each of the incorrect dependencies is shown as a respective dotted line between the tasks. Thus, display area 360 shows that the user/manager has indicated the Finish-to-Start dependency 353 and the Start-to-Start dependency 355 to be incorrect. Management tool 150 may accordingly add such indicated incorrect dependencies to the rejected list of dependencies.

In one embodiment, a user/manager in addition to either accepting or rejecting an inferred dependency, is also enabled to keep an inferred dependency “as is” (that is, as inferred or tentative), and then perform scheduling, by choosing only a subset of all such tentative dependencies. Such scheduling of tentative dependencies may be desirable, for example, when a scheduling tool used for scheduling provides a preview of the impact of scheduling (before the user/manager accepts the scheduling result). The manner in which a user/manager may specify such tentative dependencies is described in detail below.

Referring to FIG. 3D, display area 370 displays the various tasks of the project (similar to display area 320) and also the various dependencies indicated to be tentative by the user/manager. Each of the tentative dependencies is shown as a respective double dot-dashed line between the tasks. Thus, display area 370 shows that the user/manager has indicated the Finish-to-Start dependencies 351 and 352 (along with other dependencies) as tentative dependencies. It may be observed that the tentative dependencies of display area 370 form a subset of the inferred dependencies shown in display area 340 (and also does not include the rejected dependencies shown in display area 360).

The user/manager may thereafter forward the tentative dependencies to a scheduling tool (noted above) and preview the impact of scheduling of the selected tentative dependencies. The user/manger may similarly choose different desired subsets of the inferred dependencies (of display area 340) as tentative dependencies, preview the possible impact of scheduling with such different subsets of tentative dependencies and then select/accept a desirable subset (as real dependencies) based on the previewed impacts.

Thus, management tool 150 facilitates a user/manger to specify the status of the inferred dependencies. In response to receiving such status (for example, incorrect dependencies to be added to the rejected list), management tool 150 may generate a new inferred list of dependencies based on the new rejected list. The manner in which such a newly inferred list may be displayed is described in detail below.

Referring to FIG. 3E, display area 380 displays the various tasks of the project (similar to display area 320) and also the newly inferred list of dependencies based on the new rejected list (noted above). It may be observed that the newly displayed list of dependencies does not include dependencies 353 and 355 (which were indicated to be incorrect). However, the new list now includes dependency 358 between tasks A040 and A090, which was previously removed due to the redundantly inferred dependency scenario match.

It may be appreciated that by excluding the previously indicated incorrect/rejected dependencies, the user interface of display area 370 displays only the most relevant inferred dependencies to the user/manger. The overhead to the user/manager for indicating the correct (that is accepting the inferred) dependencies is accordingly further reduced.

As noted above, in a collaborative environment, users may continue to add additional tasks to a project at different time instants and the user interfaces of FIGS. 3A-3E may be updated to reflect the tasks and the corresponding dependencies which are to be used in scheduling. In one embodiment, the user/manager may send the details of the task and the corresponding accepted dependencies to a scheduling tool (not shown in FIG. 1), which in turn performs the optimization of the schedule. During such optimization, the proposed start and finish time points may be changed at least for some of the tasks, typically to ensure optimal usage of time and resources.

It should be further appreciated that the features described above can be implemented in various embodiments as a desired combination of one or more of hardware, software, and firmware. The description is continued with respect to an embodiment in which various features are operative when the software instructions described above are executed.

### 7. Digital Processing System

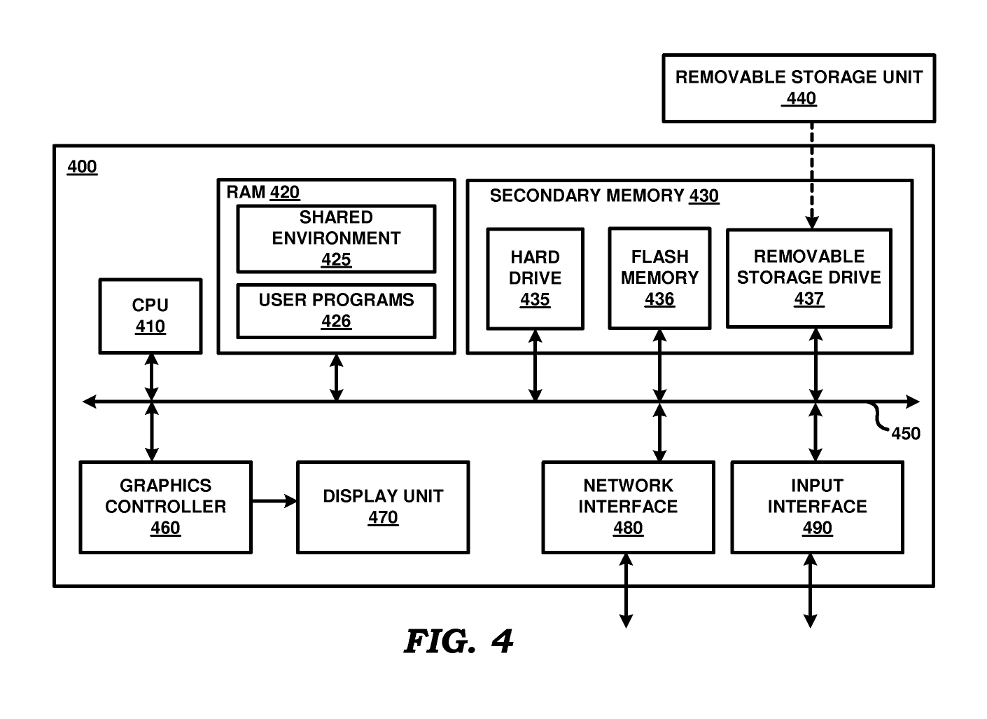

FIG. 4 is a block diagram illustrating the details of digital processing system 400 in which various aspects of the present invention are operative by execution of appropriate software instructions. Digital processing system 400 may correspond to management tool 150 or one of end user systems 160A-160X.

Digital processing system 400 may contain one or more processors such as a central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of the present invention. CPU 410 may contain multiple processing units, with each processing unit potentially being designed for a specific task. Alternatively, CPU 410 may contain only a single general-purpose processing unit.

RAM 420 may receive instructions from secondary memory 430 using communication path 450. RAM 420 is shown currently containing software instructions constituting shared environment 425 and/or user programs 426 (such as client applications, Web browser, RDBMS, etc.). Shared environment 425 includes operating systems, device drivers, virtual machines, etc., which provide a (common) run time environment for execution of user programs 426.

Graphics controller 460 generates display signals (e.g., in RGB format) to display unit 470 based on data/instructions received from CPU 410. Display unit 470 contains a display screen to display the images (e.g., portions of the user interface shown in FIGS. 3A-3D) defined by the display signals. Input interface 490 may correspond to a keyboard and a pointing device (e.g., touch-pad, mouse) and may be used to provide inputs (e.g., for interacting with the user interface shown in FIGS. 3A-3D). Network interface 480 provides connectivity to a network (e.g., using Internet Protocol), and may be used to communicate with other systems (such as those shown in FIG. 1) connected to the network.

Secondary memory 430 may contain hard drive 435, flash memory 436, and removable storage drive 437. Secondary memory 430 may store the data and software instructions (e.g., for performing the actions of FIG. 2), which enable digital processing system 400 to provide several features in accordance with the present invention.

Some or all of the data and instructions may be provided on removable storage unit 440, and the data and instructions may be read and provided by removable storage drive 437 to CPU 410. Floppy drive, magnetic tape drive, CD-ROM drive, DVD Drive, Flash memory, removable memory chip (PCMCIA Card, EEPROM) are examples of such removable storage drive 437.

Removable storage unit 440 may be implemented using medium and storage format compatible with removable storage drive 437 such that removable storage drive 437 can read the data and instructions. Thus, removable storage unit 440 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 440 or hard disk installed in hard drive 435. These computer program products are means for providing software to digital processing system 400. CPU 410 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of scheduling tasks of projects, said method comprising:
receiving a plurality of tasks of a project;
maintaining a rejected list of dependencies among said plurality of tasks;
generating an inferred list of dependencies for said plurality of tasks, wherein said generating excludes the dependencies in said rejected list from said inferred list; and
providing said inferred list of dependencies.

2. The method of claim 1, wherein said providing provides said inferred list of dependencies to a user, said method comprising:
allowing said user to specify a set of incorrectly inferred dependencies; and
adding said set of incorrectly inferred dependencies to said rejected list of dependencies.

3. The method of claim 2, wherein a proposed start time point and a proposed finish time point are received associated with each of said plurality of tasks, wherein said generating comprises:
inferring a set of dependencies based on said proposed start time point and said proposed finish time point of said plurality of tasks; and
including said set of dependencies in said inferred list.

4. The method of claim 3, further comprising:
receiving an additional set of tasks to be added to said project; and
performing said generating, said providing, said allowing and said adding with said additional set of tasks added to said plurality of tasks.

5. The method of claim 4, wherein said receiving of a corresponding additional set of tasks and said performing are performed in a plurality of iterations,
wherein the final plurality of tasks and the corresponding final inferred list of dependencies after said plurality of iterations are provided as an input to a scheduling tool for said project.

6. The method of claim 5, wherein each of said inferred list of dependencies is one of Finish-to-Start dependency and Start-to-Start dependency.

7. The method of claim 6, wherein said inferred list of dependencies includes a first set of Finish-to-Start dependencies and a second set of Start-to-Start dependencies, said method further comprising:
computing a Finish-to-Start dependency lag for each of said first set of Finish-to-Start dependencies, and a Start-to-Start dependency lag for each of said second set of Start-to-Start dependencies.

8. A non-transitory machine readable medium storing one or more sequences of instructions for causing a system to facilitate scheduling tasks of projects, wherein execution of said one or more instructions by one or more processors contained in said system causes said system to perform the actions of:
receiving a plurality of tasks of a project;
maintaining a rejected list of dependencies among said plurality of tasks;
generating an inferred list of dependencies for said plurality of tasks, wherein said generating excludes the dependencies in said rejected list from said inferred list; and
providing said inferred list of dependencies.

9. The machine readable medium of claim 8, wherein said providing provides said inferred list of dependencies to a user, further comprising one or more instructions for:
allowing said user to specify a set of incorrectly inferred dependencies; and
adding said set of incorrectly inferred dependencies to said rejected list of dependencies.

10. The machine readable medium of claim 9, wherein a proposed start time point and a proposed finish time point are received associated with each of said plurality of tasks, wherein said generating comprises one or more instructions for:
inferring a set of dependencies based on said proposed start time point and said proposed finish time point of said plurality of tasks; and
including said set of dependencies in said inferred list.

11. The machine readable medium of claim 10, further comprising one or more instructions for:
receiving an additional set of tasks to be added to said project; and
performing said generating, said providing, said allowing and said adding with said additional set of tasks added to said plurality of tasks.

12. The machine readable medium of claim 4, wherein said receiving of a corresponding additional set of tasks and said performing are performed in a plurality of iterations,
wherein the final plurality of tasks and the corresponding final inferred list of dependencies after said plurality of iterations are provided as an input to a scheduling tool for said project.

13. The machine readable medium of claim 12, wherein each of said inferred list of dependencies is one of Finish-to-Start dependency and Start-to-Start dependency.

14. The machine readable medium of claim 13, wherein said inferred list of dependencies includes a first set of Finish-to-Start dependencies and a second set of Start-to-Start dependencies, further comprising one or more instructions for:
computing a Finish-to-Start dependency lag for each of said first set of Finish-to-Start dependencies, and a Start-to-Start dependency lag for each of said second set of Start-to-Start dependencies.

15. A digital processing system comprising:
a processor;
a random access memory (RAM);
a machine readable medium to store one or more instructions, which when retrieved into said RAM and executed by said processor causes said digital processing system to facilitate scheduling tasks of projects, said digital processing system performing the actions of:
receiving a plurality of tasks of a project;
maintaining a rejected list of dependencies among said plurality of tasks;
generating an inferred list of dependencies for said plurality of tasks, wherein said generating excludes the dependencies in said rejected list from said inferred list; and
providing said inferred list of dependencies.

16. The digital processing system of claim 15, wherein said digital processing system provides said inferred list of dependencies to a user, said digital processing system further performing the actions of:
allowing said user to specify a set of incorrectly inferred dependencies; and
adding said set of incorrectly inferred dependencies to said rejected list of dependencies.

17. The digital processing system of claim 16, wherein a proposed start time point and a proposed finish time point are received associated with each of said plurality of tasks, wherein for said generating, said digital processing system performs the actions of:
inferring a set of dependencies based on said proposed start time point and said proposed finish time point of said plurality of tasks; and
including said set of dependencies in said inferred list.

18. The digital processing system of claim 17, further performing the actions of:
receiving an additional set of tasks to be added to said project; and
performing said generating, said providing, said allowing and said adding with said additional set of tasks added to said plurality of tasks.

19. The digital processing system of claim 18, wherein said receiving of a corresponding additional set of tasks and said performing are performed in a plurality of iterations,
wherein the final plurality of tasks and the corresponding final inferred list of dependencies after said plurality of iterations are provided as an input to a scheduling tool for said project.

20. The digital processing system of claim 19, wherein each of said inferred list of dependencies is one of Finish-to-Start dependency and Start-to-Start dependency, wherein said inferred list of dependencies includes a first set of Finish-to-Start dependencies and a second set of Start-to-Start dependencies, said digital processing system further performing the actions of:
computing a Finish-to-Start dependency lag for each of said first set of Finish-to-Start dependencies, and a Start-to-Start dependency lag for each of said second set of Start-to-Start dependencies.
